(19) United States
(12) Patent Application Publication
(10) Pub. No.: US 2008/0277542 A1
(43) Pub. Date: Nov. 13, 2008

(54) Chair backrest mounting bracket

(76) Inventor: Shun Hwong, Taipei (TW)

Correspondence Address: Muncy, Geissler, Olds & Lowe, PLLC, P.O. BOX 1364, FAIRFAX, VA, 22038-1364, US

(21) Appl. No.: 11/798,156

(22) Filed: May 10, 2007

(51) Int. Cl. F16B 12/00; F16M 11/00

(52) U.S. Cl. 248/200; 248/207

(57) ABSTRACT

A chair backrest mounting bracket includes a highly elastic main body for disposing between a chair backrest and a backrest support; a rigid middle fixing seat embedded in a middle section of the main body and having a centered middle mounting hole for a middle bolt to extend therethrough into a threaded hole correspondingly provided on the backrest support; and a plurality of rigid side fixing seats symmetrically embedded in opposite outer ends of the main body and having a centered side mounting hole each for a side bolt to extend therethrough into a threaded hole correspondingly provided on the chair backrest. Since the main body is elastically deformable under an externally applied force, the chair backrest connected to the backrest support via the mounting bracket is allowed to freely elastically deflect relative to the backrest support.

### FIELD OF THE INVENTION

The present invention relates to a chair backrest mounting bracket, and more particularly, to a chair backrest mounting bracket providing excellent elastic deformability and structural strength.

### BACKGROUND OF THE INVENTION

In most conventional chair backrest structures, a substantially flat backrest is directly fixedly connected to a rear edge of a seat or rear ends of two armrests of the chair. Alternatively, the backrest is mounted to a backrest support upward extended from the seat or the armrests. Therefore, most conventional chair backrests are fixedly or immovably relative to the seat or armrests.

Some other chair backrest structures include an elastically bendable and deformable backrest support upward extended from a rear edge of a seat, so that a chair backrest connected to a top of the backrest support is allowed to incline rearward and therefore more comfortable for leaning. It is noted, however, the chair backrest is connected to the elastically deformable backrest support via a rigid and non-deformable mounting bracket. When the rigid mounting bracket is completely closely fixed to and between the chair backrest and the backrest support, the chair back rest is allowed to bend, that is, to incline forward or rearward, only in an elastic deformation direction of the backrest support. Therefore, the rigid and non-deformable back rest mounting bracket does not allow the chair backrest connected to the elastically deformable support to be comfortable enough to meet users' requirement. On the other hand, when a clearance is left between the rigid backrest mounting bracket and the chair backrest and the backrest support to allow the chair backrest to deflect in more different directions relative to the backrest support, the backrest tends to shake and sway due to incomplete contact with the mounting bracket. Such shaking and swaying backrest would inevitably adversely affect the consumer's trust and interest in the chair.

It is therefore tried by the inventor to develop an improved chair backrest mounting bracket to eliminate the drawbacks in the prior art.

### SUMMARY OF THE INVENTION

A primary object of the present invention is to provide a chair backrest mounting bracket that has good connection strength and allows a chair backrest connected to a corresponding backrest support via the mounting bracket to elastically deflect relative to the backrest support without causing shaking or incomplete contact, so that the chair backrest has increased assembling quality and upgraded competing ability in the market.

Another object of the present invention is to provide a chair backrest mounting bracket that has simple structure to effectively reduce the manufacturing cost thereof.

To achieve the above and other objects, the chair backrest mounting bracket according to the present invention includes an elastically bendable and deformable main body for disposing between a chair backrest and a backrest support; a highly rigid middle fixing seat embedded in a middle section of the main body and having a centered middle mounting hole for a middle fastening element to extend therethrough into a threaded hole correspondingly provided on the backrest support; and a plurality of highly rigid side fixing seats symmetrically embedded in opposite outer ends of the main body and having a centered side mounting hole each for a side fastening element to extend therethrough into a threaded hole correspondingly provided on the chair backrest.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a chair back rest mounting bracket according to a preferred embodiment of the present invention;

FIG. 2 is a sectional view taken on line A-A of FIG. 1;

FIG. 3 shows the use of the present invention to mount a chair backrest to a backrest support;

FIG. 4 is a sectioned side view showing the mounting of a chair backrest to a backrest support via the present invention;

FIG. 5 shows the chair backrest mounted to the backrest support via the present invention is allowed to incline backward; and

FIG. 6 shows the chair backrest mounted to the backrest support via the present invention is allowed to turn sidewardly.

### DETAILED DESCRIPTION OF THE PREFERRED EMBODIMENTS

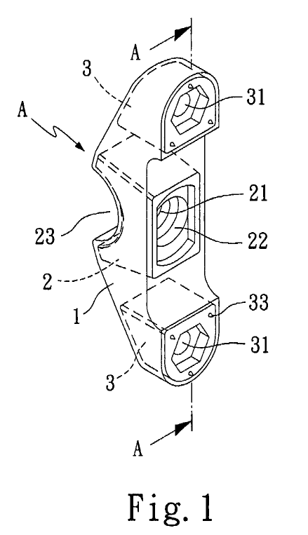

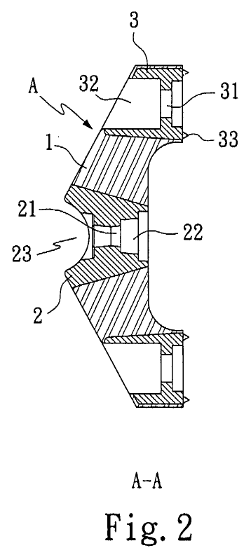

Please refer to FIG. 1 that is a perspective view of a chair backrest mounting bracket “A” according to a preferred embodiment of the present invention, and to FIG. 2 that is a sectional view taken along line A-A of FIG. 1. As shown, the chair backrest mounting bracket A includes a main body 1, a middle fixing seat 2 and a plurality of side fixing seats 3. The main body 1 is made of a soft material with high elasticity, such as rigid rubber material, so as to provide restorable bending, twisting, or deformation when the chair backrest mounting bracket A bears an externally applied force.

The middle fixing seat 2 is made of a hard material with high rigidity, such as plastic or metal material, and is embedded in a middle or central section of the main body 1. The middle fixing seat 2 has a centered through hole forming a middle mounting hole 21, an end of which is formed into a spot face 22, and the other end of which a transversely extended curved recess 23.

The side fixing seats 3 are also made of a hard material with high rigidity, such as plastic or metal material, and symmetrically embedded in opposite outer ends of the main body 1. Each of the side fixing seats 3 has a centered through hole forming a side mounting hole 31. An end of the side mounting hole 31 adjacent to the curved recess 23 is formed into a spot face 32, and the other end of the side mounting hole 31 opposite to the spot face 32 is provided along an outer periphery with a plurality of spaced pointed teeth 33.

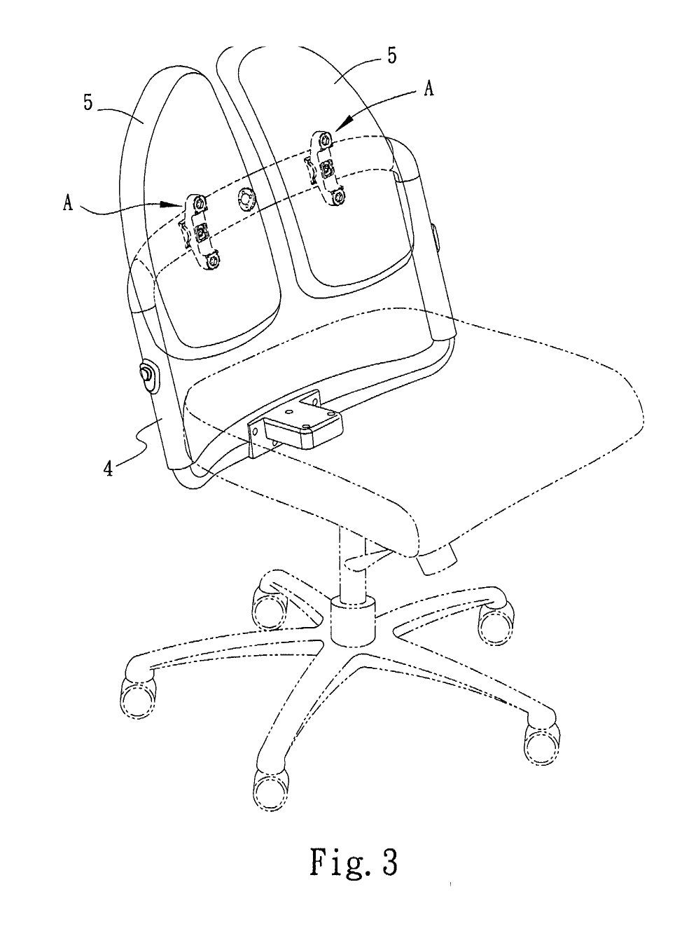

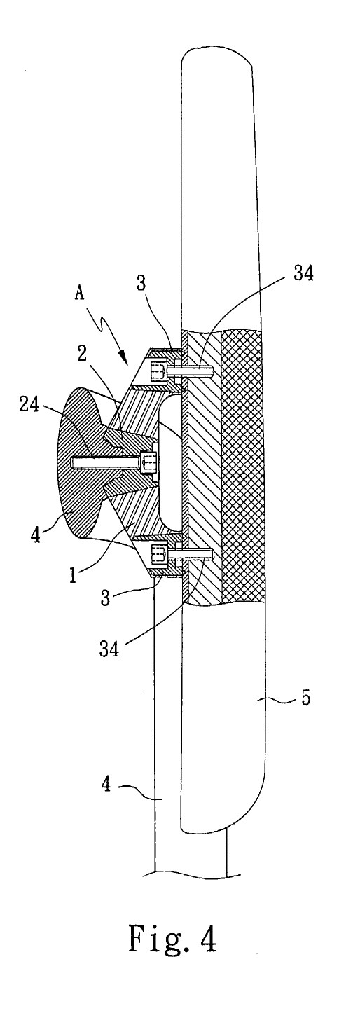

FIGS. 3 and 4 are perspective and sectioned side view, respectively, showing the use of the chair backrest mounting bracket A of the present invention to connect a chair backrest 5 to a backrest support 4. As shown, to connect the chair backrest 5 to the backrest support 4 via the mounting bracket A of the present invention, first firmly associate the curved recess 23 of the middle fixing seat 2 with a transverse section of the backrest support 4 by extending a middle bolt 24 from the spot face 22 through the middle mounting hole 21 into a threaded hole correspondingly provided on the backrest support 4. Thereafter, firmly attach the side fixing seats 3 to the chair backrest 5 by piercing the plurality of pointed teeth 33 into a rear surface of the backrest 5 and screwing a plurality of side bolts 34 from the spot faces 32 through the side mounting holes 31 into threaded holes correspondingly provided on the chair backrest 5. As a result, the chair backrest 5 is firmly and stably connected to the backrest support 4 via the mounting bracket A.

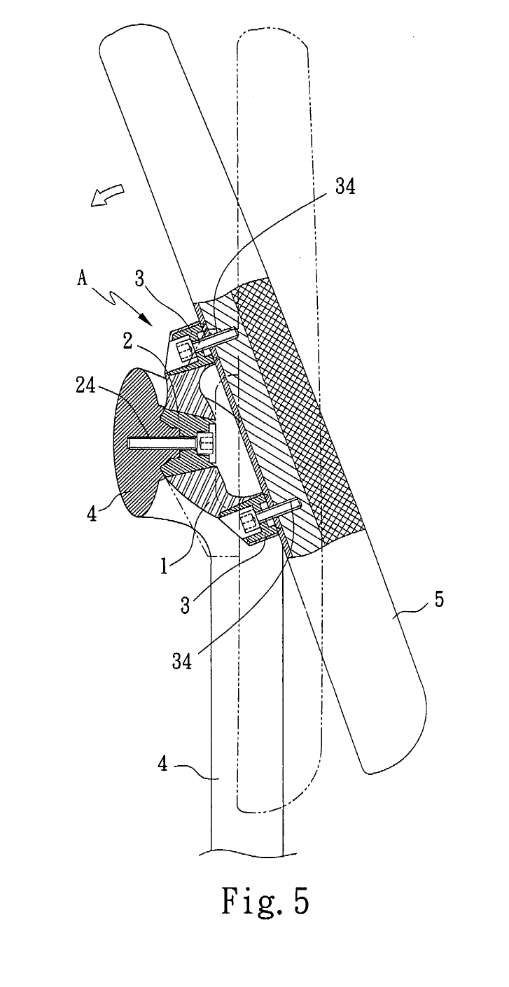

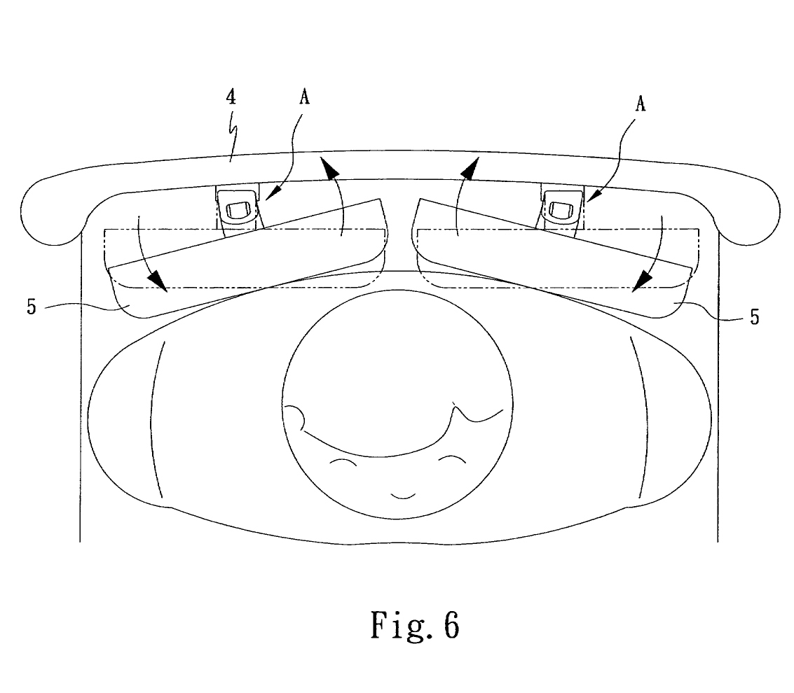

Please refer to FIGS. 5 and 6. Since the main body 1 of the mounting bracket A of the present invention is elastically bendable and twistable when it is subjected to an external force, the chair backrest 5 connected to the backrest support 4 via the mounting bracket A is allowed to elastically incline backward as shown in FIG. 5, or to elastically turn sidewardly as shown in FIG. 6 in response to a user's sitting position. Therefore, the chair backrest 5 is able to provide the most comfortable supporting effect.

It is noted the middle fixing seat 2 and the side fixing seats 3 are closely connected to the backrest support 4 and the chair backrest 5, respectively, without loosely leaving any clearance between them. Moreover, the elastically deformable main body 1 allows the chair backrest 5 to incline backward or turn rightward and sideward relative to the backrest support 4 without causing shaking or swaying. The chair backrest mounting bracket of the present invention has simple structure but excellent strength and is easy to mount to enable not only effectively reduced manufacturing cost, but also prolonged usable life and enhanced competing ability in the market.

1. A mounting bracket for mounting a chair backrest to a bracket support, comprising:
a middle fixing seat made of a material with high rigidity and embedded in a middle section of the mounting bracket, the middle fixing seat having a centered through hole forming a middle mounting hole, through which a middle fastening element is extended into a corresponding position on the backrest support to connect the main body to the backrest support;
a plurality of side fixing seats made of a material with high rigidity and symmetrically embedded in opposite outer ends of the mounting bracket, each of the middle fixing seats having a centered through hole forming a side mounting hole, through which a side fastening element is extended into a corresponding position on the chair backrest to connect the main body to the chair backrest; and
a main body made of a bendable and deformable elastic material joining said middle fixing seat to each side fixing seat so that said side fixing seats extend towards said chair backrest beyond said middle fixing seat and said middle fixing seat extends towards said bracket support beyond said side fixing seats.

2. The chair backrest mounting bracket as claimed in claim 1, wherein the middle mounting hole of the middle fixing seat is formed at an end closer to the backrest support with a curved recess for correspondingly associating with the backrest support.

3. The chair backrest mounting bracket as claimed in claim 1, wherein each of the side fixing seats is provided at an end closer to the chair backrest with a plurality of pointed teeth for piercing into a rear surface of the chair backrest.

4. The chair backrest mounting bracket as claimed in claim 1, wherein the middle fastening element and the side fastening elements are screw bolts.

5. The chair backrest mounting bracket as claimed in claim 1, wherein an end of the middle mounting hole closer to the chair backrest is formed into a recessed face, and an end of each of the side mounting holes farther from the chair backrest is formed into a recessed face.
